(19) United States
(12) Patent Application Publication
(10) Pub. No.: US 2010/0082219 A1
(43) Pub. Date: Apr. 1, 2010

(54) Engine Using Glow Plug Resistance For Estimating Combustion Temperature

(75) Inventor: Qi Ma, Farmington Hills, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., Detroit, MI (US)

(21) Appl. No.: 12/241,419

(22) Filed: Sep. 30, 2008

(51) Int. Cl. F02D 45/00

(52) U.S. Cl. 701/102; 123/145 A

(57) ABSTRACT

An internal combustion engine includes an engine block defining at least one cylinder therein. A cylinder head is attached to the engine block and defines a combustion chamber with the at least one cylinder in the engine block. A piston is disposed within the at least one cylinder. A glow plug is disposed within the combustion chamber. A resistance of the glow plug is detected and an estimated combustion temperature is determined based upon the detected resistance of the glow plug. The engine is then controlled based upon the estimated combustion temperature established from the glow plug resistance.

### FIELD

The present disclosure relates to internal combustion engines, and more particularly, to an engine using glow plug resistance for estimating combustion temperature.

### BACKGROUND

The statements in this section merely provide background information related to the present disclosure and may not constitute prior art.

In theory, diesel engines and gasoline engines are quite similar. They are both internal combustion engines designed to convert the chemical energy available in fuel into mechanical energy. This mechanical energy moves pistons up and down inside cylinders. The pistons are connected to a crankshaft, and the up-and-down motion of the pistons, known as linear motion, creates the rotary motion needed to turn the wheels of a car.

Both diesel engines and gasoline engines covert fuel into energy through a series of small explosions or combustions. The major difference between diesel and gasoline is the way these explosions happen. In a gasoline engine, fuel is mixed with air, compressed by pistons and ignited by sparks from spark plugs. In a diesel engine, however, the air is compressed first, and then the fuel is injected. Because air heats up when it's compressed, the fuel ignites.

The diesel engine uses a four-stroke combustion cycle just like a gasoline engine. The four strokes are:
Intake stroke—The intake valve opens up, letting in air and moving the piston down.
Compression stroke—The piston moves back up and compresses the air.
Combustion stroke—As the piston reaches the top, fuel is injected at just the right moment and ignited, forcing the piston back down.
Exhaust stroke—The piston moves back to the top, pushing out the exhaust created from the combustion out of the exhaust valve. The diesel engine has no spark plug, the engine intakes air and compresses it, and it then injects the fuel directly into the combustion chamber (direct injection). It is the heat of the compressed air that lights the fuel in a diesel engine.

Some diesel engines contain a glow plug. When a diesel engine is cold, the compression process may not raise the air to a high enough temperature to ignite the fuel. The glow plug is an electrically heated element that heats the combustion chambers and raises the temperature within the combustion chamber when the engine is cold so that the engine can start. After the engine is heated up, the glow plug is no longer needed during the engine operation.

All functions in a modern engine are typically controlled by the engine control unit communicating with an elaborate set of sensors measuring everything from R.P.M. to engine coolant and oil temperatures and piston position. The engine control unit senses ambient air temperature and retards the timing of the engine in cold weather so the injector sprays the fuel at a later time. The air in the cylinder is compressed more, creating more heat, which aids in starting.

Advanced diesel engine control requires a good knowledge of combustion temperature and exhaust temperature in order to provide efficient engine controls. A temperature sensor placed within or in proximity to the combustion chamber is one known method of detecting the combustion temperature, but is an expensive solution. Further, a regression or model-based temperature model is an alternative solution but requires extensive experimental and calibration work in order to estimate the combustion temperature under a wide range of operating conditions. It is desirable in the internal combustion art to provide a reliable, inexpensive technique for determining the combustion temperature for use in engine control systems.

### SUMMARY

An internal combustion engine includes an engine block defining at least one cylinder therein. A cylinder head is attached to the engine block and defines a combustion chamber with the at least one cylinder in the engine block. A piston is disposed within the at least one cylinder. A glow plug is disposed within the combustion chamber. A resistance of the glow plug is detected and an estimated combustion temperature is determined based upon the detected resistance of the glow plug. The engine is then controlled based upon the estimated combustion temperature established from the glow plug resistance.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a fragmentary cross-sectional view of an exemplary prior art diesel engine having a glow plug disposed in the combustion chamber; and

FIG. 2 is a schematic view of a glow plug resistance detection circuit in communication with an engine controller according to the principles of the present disclosure.

### DETAILED DESCRIPTION

The following description is merely exemplary in nature and is not intended to limit the present disclosure, application, or uses.

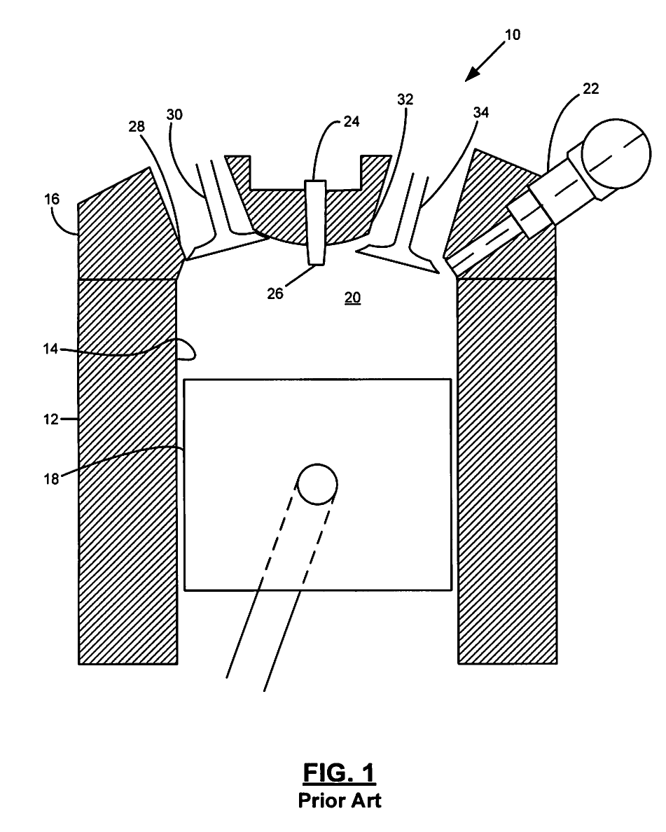

With reference to FIG. 1, an exemplary diesel engine is shown having a glow plug disposed within the combustion chamber. In particular, the diesel engine 10 has a cylinder block 12 defining at least one cylinder 14 closed by a cylinder head 16. It should be understood that a typical engine includes a plurality of cylinders 14. A piston 18 is reciprocable in the cylinder 14, and together with the cylinder head 16, forms a combustion chamber 20. The cylinder head 16 mounts an injection nozzle or injector 22 which sprays fuel into the combustion chamber 20 for compression ignition therein. The cylinder head also mounts a known form of a glow plug 24 having a glow tip 26 extending into the combustion chamber 20. The glow tip 26 is heated during cold engine starting and low temperature operation to assist in igniting fuel sprayed into the combustion chamber 20 during periods when the temperature of compression may be insufficient to provide for proper fuel combustion. The illustrated glow plug 24 is of the type having a metallic sheath forming a glow tip 26. It should be understood that other forms of glow plugs can be utilized with the present disclosure. In addition, the location of the injector 22 and glow plug 24 can be varied. The cylinder head 16 defines an intake port 28 including an intake valve 30 disposed therein and an exhaust port 32 having an exhaust valve 34 disposed therein. The position of the intake and exhaust ports 28, 32 can also be varied.

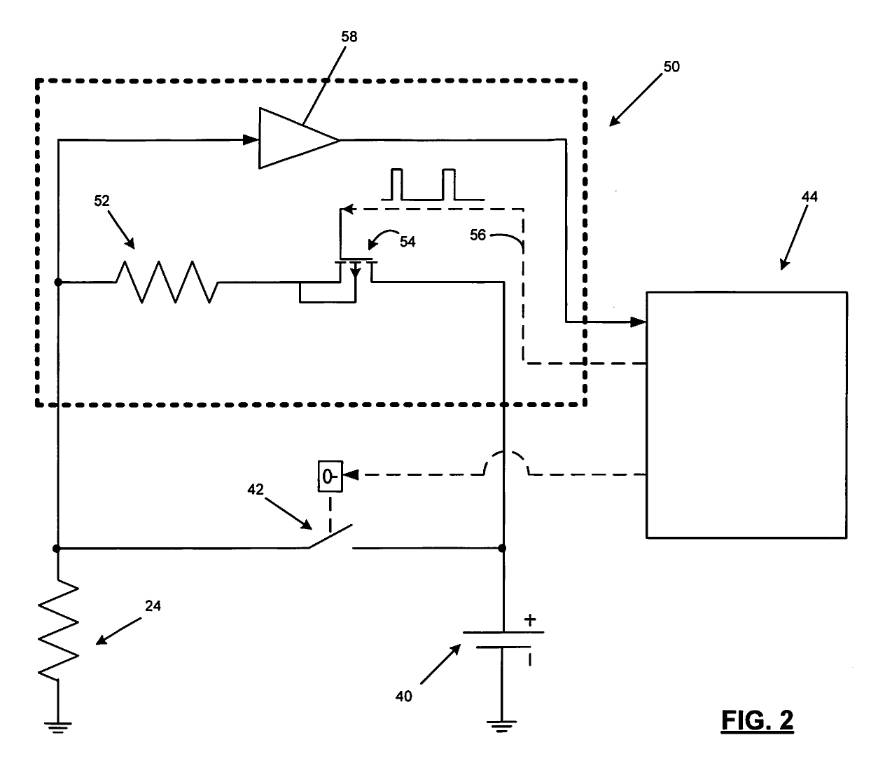

The glow plug 24 is typically operable for a cold engine start and remains idle after the engine is warmed up. As shown in FIG. 2, the glow plug 24 is shown as being connected to a vehicle battery 40 by a power relay device 42 that is operable by an engine control unit 44 or another onboard control. The engine control unit 44 determines when the glow plug 24 needs to be operated at engine cold start. The engine control unit 44 also determines when to deactivate the glow plug 24 when the engine 10 has warmed up. According to the principles of the present disclosure, the resistance of the glow plug 24 is temperature dependent such that by detecting the resistance of the glow plug 24, the temperature of the combustion chamber can be estimated. The circuit 50 is connected to the glow plug 24 and includes a current sensing resistor 52. A power MOSFET or other switch device 54 is controlled by control signal 56 received from the engine control unit 44 or other onboard controller for connecting the current sensing resistor 52 to the glow plug 24 and battery 40. An op amp 58 is provided in parallel with the current sensing resistor for providing a signal to the engine control unit 44, indicative of the resistance of the glow plug 24 and the signal received from the op amp 58 is then translated by the engine control unit 44 into a corresponding combustion chamber temperature. The engine control unit 44 can associate the signal from the op amp 58 with a look-up table or other conversion means for estimating the combustion chamber temperature.

It should be understood that other alternative circuits to the circuit 50 can be utilized for determining the resistance of the glow plug 24 in order to allow the engine control unit or other microcontroller 44 to estimate the combustion chamber temperature. The estimated combustion chamber temperature can be determined based upon a correlation map between measured glow plug resistance levels and known combustion chamber temperatures. Furthermore, an additional correlation map can be calculated to provide a correlation between the estimated combustion temperature and the exhaust temperature. The estimated combustion temperature and exhaust temperature can then be utilized by the control unit 44 for controlling the engine operation including fuel injection timing.

With the system of the present disclosure, the glow plug is used to heat up the combustion chamber during low temperature engine start-up in many diesel engines. The heater element is a temperature sensitive resistor. For a given glow plug, the temperature sensitive characteristics such as the resistance can be characterized by a look-up table. During normal operating conditions, the glow plug is not powered, but is heated by the combustion events. With a simple voltage divider circuit, the resistance of the glow plug can be obtained and, therefore, the combustion chamber temperature can be derived. With the system of the present disclosure, existing cylinder pressure sensors and exhaust temperature sensors can be eliminated with very little added cost for the divider circuitry. This system further enables individual cylinder control without significant added expenditure.

What is claimed is:

1. An internal combustion engine, comprising:
an engine block defining at least one cylinder therein;
a cylinder head attached to said engine block and defining a combustion chamber with said at least one cylinder in said engine block;
a piston disposed within said at least one cylinder;
a glow plug disposed within said combustion chamber; and
means for detecting a resistance of said glow plug and determining an estimated combustion temperature based upon the detected resistance of said glow plug.

2. The internal combustion engine according to claim 1, wherein said means for detecting a resistance of said glow plug includes a circuit including a current sensing resistor for providing a sensed current to an engine control unit.

3. An internal combustion engine, comprising:
an engine block defining at least one cylinder therein;
a cylinder head attached to said engine block and defining a combustion chamber with said at least one cylinder in said engine block;
a piston disposed within said at least one cylinder;
a glow plug disposed within said combustion chamber;
an engine controller associated with the internal combustion engine and controlling operation of said glow plug; and
a circuit connected to said glow plug for detecting a resistance of said glow plug and providing a signal to said engine controller for determining an estimated combustion temperature based upon the detected resistance of said glow plug.

4. The internal combustion engine according to claim 3, wherein said circuit includes a current sensing resistor for providing a sensed current to said engine control unit.

5. A method of estimating a combustion chamber temperature for an internal combustion engine having a glow plug within the combustion chamber, comprising:
operating the engine;
detecting a resistance of the glow plug; and
associating the detected resistance with an estimated combustion chamber.

6. The method according to claim 5, further comprising operating said internal combustion engine based upon said estimated combustion chamber.
